(19) United States
(12) Patent Application Publication
(10) Pub. No.: US 2018/0026543 A1
(43) Pub. Date: Jan. 25, 2018

(54) APPARATUS AND METHOD FOR CONTROLLING SYNCHRONIZING RECTIFIER OF LDC

(71) Applicants: Hyundai Motor Company, Seoul (KR); Kia Motors Corporation, Seoul (KR)

(72) Inventors: Dae Woong HAN, Anyang-si (KR); Jeong Bin YIM, lncheon (KR); Jae Hwa JEON, Hwaseong-si (KR); Sang Kyu LEE, Yongin-si (KR)

(73) Assignees: Hyundai Motor Company, Seoul (KR); Kia Motors Corporation, Seoul (KR)

(21) Appl. No.: 15/349,770

(22) Filed: Nov. 11, 2016

(30) Foreign Application Priority Data
Jul. 20, 2016 (KR) 10-2016-0091888

(51) Int. Cl. H02M 3/335; B60L 11/18

(52) U.S. Cl. CPC H02M 3/33592; B60L 11/18

(57) ABSTRACT

An apparatus for controlling a synchronizing rectifier of a low voltage direct current (DC)-DC converter (LDC) may include a receiver receiving an LDC output command voltage, and a controller controlling an operation of the synchronizing rectifier based on the received LDC output command voltage.

### CROSS-REFERENCE TO RELATED APPLICATION

The present application claims priority to Korean Patent Application No. 10-2016-0091888, filed Jul. 20, 2016, the entire contents of which is incorporated herein for all purposes by this reference.

### BACKGROUND OF THE INVENTION

### Field of the Invention

The present invention relates to an apparatus and a method for controlling a synchronizing rectifier of a low voltage direct current (DC)-DC converter (LDC), and more particularly, to a technology capable of efficiently preventing a reverse powering phenomenon occurring by a synchronizing rectifier of an LDC provided in an environmentally friendly vehicle.

In the present invention, an environmentally friendly vehicle, which is a vehicle driven by driving an electric motor using a high voltage battery, includes a hybrid electric vehicle (HEV), an electric vehicle (EV), a plug-in hybrid electric vehicle (PHEV), a fuel cell electric vehicle (FCEV), and the like.

### Description of Related Art

A low voltage direct current (DC)-DC converter (LDC) is a device stepping down a voltage (200V to 400V) of a high voltage battery of an environmentally friendly vehicle into a low voltage (12V to 14V) that may be used in 12V electric loads (a lamp, an actuator, an audio, and the like) of the vehicle.

The LDC controls a primary-side semiconductor switch (a metal oxide semiconductor field effect transistor (MOSFET)) to convert a DC voltage (Vin) of the high voltage battery into an alternating current (AC) voltage, steps down the converted AC voltage into a low AC voltage (12V to 14V) using a transformer (Tr), rectifies the low AC voltage to be a DC voltage through a secondary-side synchronizing rectifier (a MOSFET), passes the rectified DC voltage through a filter (Lf-Cf), and then supplies a stable DC voltage Vₒ to the electric loads of the vehicle. Here, the synchronizing rectifier may decrease conduction loss to raise efficiency of the LDC by about 3 to 4%.

A current may flow bi-directionally in the synchronizing rectifier unlike a diode, and in the case in which an output voltage Vₒ of the LDC is less than a voltage V_{BATT} of an auxiliary battery by an LDC output command voltage V_{ref}, a reverse powering phenomenon that an output current I_{LDC} of the LDC does not flow toward the electric loads, but flows toward the high voltage battery occurs.

The less the number of electric loads, the higher the probability that the reverse powering phenomenon will occur, and since the reverse powering phenomenon instantaneously generates a large current, it damages to components of the LDC, such as the synchronizing rectifier, a gate driving circuit, and the like.

Therefore, a method capable of preventing the reverse powering phenomenon by the synchronizing rectifier is required.

As the related art, a method of indirectly estimating an output current I_{LDC} of the LDC using a current transformer (CT) that has been necessarily applied to a primary side of the LDC and has been already used for pulse width modulation (PWM) control and protection and then controlling the synchronizing rectifier on the basis of the output current I_{LDC} has been suggested.

As an example, the output current I_{LDC} of the LDC may be estimated according to following Equation 1 and Equation 2.

$$η = \frac{{P}_{out}}{{P}_{in}} = \frac{{V}_{out} \times {I}_{LDC}}{{V}_{in} \times {I}_{in}} \qquad [ Equation 1 ]$$

Here, Pᵢₙ indicates an input power, Pₒᵤₜ indicates an output power, and η indicates efficiency of the LDC.

$${I}_{LDC} = \frac{{V}_{in} \times {I}_{in} \times η}{{V}_{out}} \qquad [ Equation 2 ]$$

Here, Vᵢₙ indicates an input voltage, Iᵢₙ indicates an input current, η indicates efficiency of the LDC, and Vₒᵤₜ indicates an output voltage.

In the related are described above, the output current of the LDC may not be estimated at a high accuracy due to a time delay of a low pass filter (LPF) positioned adjacently to the current transformer (CT) and a component error (about 1%) of a signal amplifier (OP-AMP), such that the reverse powering phenomenon may not be perfectly prevented.

Particularly, in an ultra-low load (0 to 1 A) environment, the reverse powering phenomenon more frequently occurs to cause larger damage to the components of the LDC.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus and a method for controlling a synchronizing rectifier of a low voltage direct current (DC)-DC converter (LDC) provided in an environmentally friendly vehicle capable of perfectly preventing a reverse powering phenomenon even in an ultra-low load environment without performing a process of estimating an output current of the LDC by controlling an operation of the synchronizing rectifier in the LDC on the basis of an output voltage of the LDC.

According to various aspects of the present invention, an apparatus for controlling a synchronizing rectifier of a low voltage direct current (DC)-DC converter (LDC) may include a receiver receiving an LDC output command voltage, a controller controlling an operation of the synchronizing rectifier based on the received LDC output command voltage.

The controller may operate the synchronizing rectifier when the LDC output command voltage exceeds a threshold value, and stop an operation of the synchronizing rectifier when the LDC output command voltage does not exceed the threshold value.

The controller may again operate the synchronizing rectifier that is in a stop state when an LDC output command voltage exceeding the threshold value is newly received.

According to various aspects of the present invention, a method for controlling a synchronizing rectifier of an LDC may include receiving, by a receiver, an LDC output command voltage, and controlling, by a controller, an operation of the synchronizing rectifier based on the received LDC output command voltage.

The controlling may include operating the synchronizing rectifier when the LDC output command voltage exceeds a threshold value, and stopping an operation of the synchronizing rectifier when the LDC output command voltage does not exceed the threshold value.

The controlling may include again operating the synchronizing rectifier that is in a stop state when an LDC output command voltage exceeding the threshold value is newly received.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a circuit diagram of a low voltage direct current (DC)-DC converter (LDC) provided in an environmentally friendly vehicle according to various embodiments of the present invention.

FIG. 2 is a block diagram of an apparatus for controlling a synchronizing rectifier of an LDC according to various embodiments of the present invention.

FIG. 3 is an illustrative view illustrating performance of the apparatus for controlling a synchronizing rectifier of an LDC according to various embodiments of the present invention.

FIG. 4 is another illustrative view illustrating performance of the apparatus for controlling a synchronizing rectifier of an LDC according to various embodiments of the present invention.

FIG. 5 is still another illustrative view illustrating performance of the apparatus for controlling a synchronizing rectifier of an LDC according to various embodiments of the present invention.

FIG. 6 is a flow chart of a method for controlling a synchronizing rectifier of an LDC according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

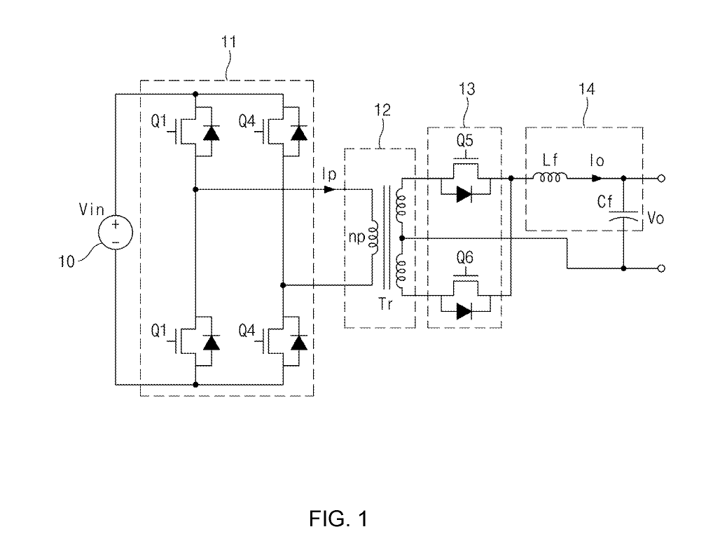

FIG. 1 is a circuit diagram of a low voltage direct current (DC)-DC converter (LDC) provided in an environmentally friendly vehicle according to various embodiments of the present invention.

As illustrated in FIG. 1, the LDC provided in the environmentally friendly vehicle according to various embodiments of the present invention may include a high voltage battery 10, a DC-alternating current (AC) converter 11, a transformer 12, a synchronizing rectifier 13, and a filter 14.

First, the high voltage battery 10 provides driving power to the environmentally friendly vehicle, and provides a voltage to an auxiliary battery or electric loads.

The DC-AC converter 11 converts a DC voltage Vin of the high voltage battery 10 into an AC voltage.

The transformer 12 steps down the AC voltage converted by the DC-AC converter 11 into a low AC voltage (12V to 14V).

The synchronizing rectifier 13 rectifies the AC voltage stepped down by the transformer 12 to be a DC voltage.

The filter 14, which is an Lf-Cf filter, outputs a stable DC voltage Vₒ.

In the LDC including the components described above, since conduction loss may be decreased through the synchronizing rectifier 13, efficiency of the LDC may be improved. This case corresponds to a case in which the synchronizing rectifier 13 is operated, and in the case in which the synchronizing rectifier 13 is not operated, efficiency of the LDC may not be improved, and a general rectifying process is performed.

Therefore, a point in time in which a reverse powering phenomenon occurs is accurately decided, and an operation of the synchronizing rectifier 13 should be stopped only at the corresponding point in time without a time delay in order to improve the efficiency of the LDC. In various embodiments of the present invention, the operation of the synchronizing rectifier 13 is controlled in consideration of a relationship between an LDC output command voltage and an output voltage of the LDC, thereby preventing the reverse powering phenomenon and improving the efficiency of the LDC.

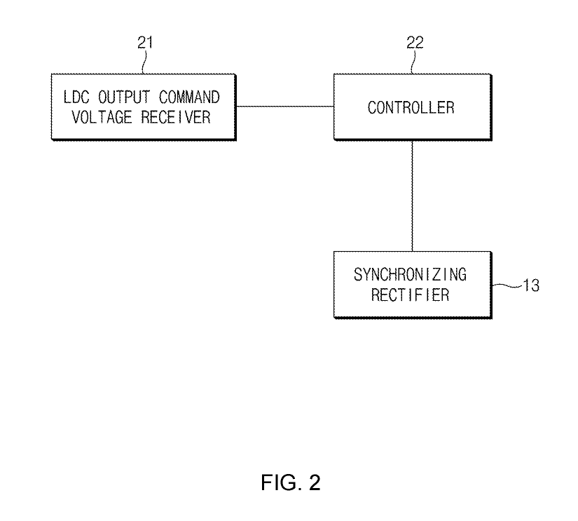

FIG. 2 is a block diagram of an apparatus for controlling a synchronizing rectifier of an LDC according to various embodiments of the present invention.

As illustrated in FIG. 2, the apparatus for controlling a synchronizing rectifier of an LDC according to various embodiments of the present invention may include an LDC output command voltage receiver 21 and a controller 22. Hereinafter, although an example in which the LDC output command voltage receiver 21 is implemented as a separate module has been described in various embodiments of the present invention, the controller 22 may also be implemented to perform all of functions of the LDC output command voltage receiver 21 depending on a program command stored in a memory.

The respective components will be described. First, the LDC output command voltage receiver 21 receives an LDC output command voltage from a hybrid control unit (HCU), which is an upper controller.

For reference, the HCU determines a control priority in consideration of durability of the auxiliary battery, deterioration of driving performance depending on the use of the electric loads, and the like, and determines an LDC voltage control mode depending on a driving situation such as a gear lever, whether or not a fuel is injected, a vehicle speed, a motor torque, LDC consumed power, or the like, in the case in which a voltage control of the LDC is normally possible. Here, the LDC voltage control mode is determined for each of at most seven driving conditions (a vehicle stop state, a deceleration section, an EV mode, an idle state, an HEV mode, a P-stage stop, a reverse movement state, and the like) on the basis of the gear lever, whether or not the fuel is injected, the vehicle speed, the motor torque, the LDC consumed power, or the like.

In addition, the LDC output command voltage receiver 21 may receive an LDC output command voltage through a vehicle network.

Here, the vehicle network includes a controller area network (CAN), a local interconnection network (LIN), a FlexRay, a media oriented system transport (MOST), and the like.

Next, the controller 22 performs a general control so that the respective components described above may normally perform their functions.

Particularly, the controller 22 controls an operation of the synchronizing rectifier 13 on the basis of the LDC output command voltage received by the LDC output command voltage receiver 21.

That is, the controller 22 operates (on) the synchronizing rectifier 13 when the LDC output command voltage exceeds a threshold value, and stops (off) an operation of the synchronizing rectifier 13 otherwise. Here, the threshold value is preferably 13.1V higher than 13V by 0.1V in the case of an auxiliary battery having a voltage of 13V when a state of charge (SOC) is 100%.

Then, the controller 22 maintains an operation stop state of the synchronizing rectifier 13 until an LDC output command voltage exceeding the threshold value is received. That is, the controller 22 operates the synchronizing rectifier 13 that is in the stop state when the LDC output command voltage exceeding the threshold value is received.

As a result, the controller 22 operates the synchronizing rectifier 13 only in the case in which the LDC output command voltage exceeding the threshold value is received.

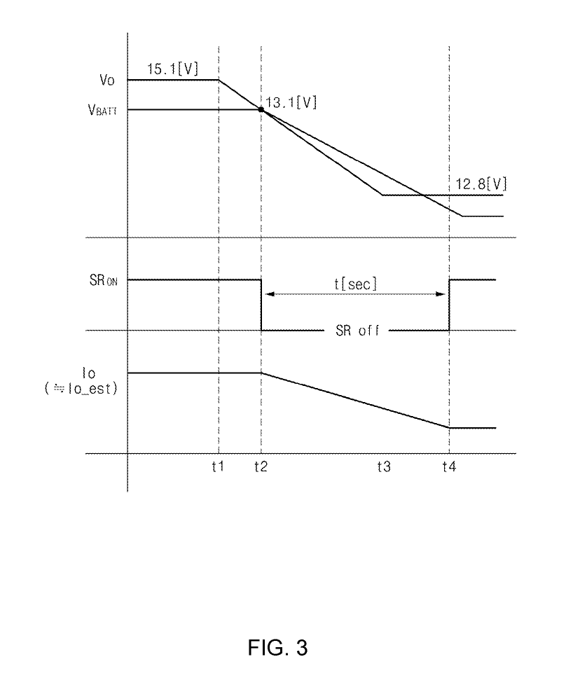

FIG. 3, which is an illustrative view illustrating performance of the apparatus for controlling a synchronizing rectifier of an LDC according to various embodiments of the present invention, illustrates a process of controlling an operation of the synchronizing rectifier on the basis of an output voltage of the LDC when the LDC output command voltage Vref is stepped down from 15.1[V] to 12.8[V].

In the case in which the upper controller steps down the LDC output command voltage V_{ref} from 15.1[V] to 12.8[V] at a point in time ‘a’ and maintains this state until a point in time ‘t4’ during a period in which the vehicle is driven, an output voltage Vₒ of the LDC is slowly stepped down depending on the LDC output command voltage V_{ref} and becomes lower than a voltage V_{BATT} of the auxiliary battery at a point in time ‘t2,’ such that a reverse powering phenomenon occurs.

Here, the controller 22 stops the operation of the synchronizing rectifier 13 for t seconds from the point in time ‘t2’ to the point in time ‘t4’ to prevent the reverse powering phenomenon, thereby making it possible to stably prevent the reverse powering phenomenon without a time delay by a filter or an operational amplifier (OP-AMP) to prevent damage to components of the LDC.

In a state in which the operation of the synchronizing rectifier 13 is stopped as described above, a power transfer is generated through a diode in the synchronizing rectifier 13. However, since efficiency of the LDC may be deteriorated in the state in which the operation of the synchronizing rectifier 13 is stopped as compared with the case in which the synchronizing rectifier 13 is operated, it is preferable that an operation stop time is not long.

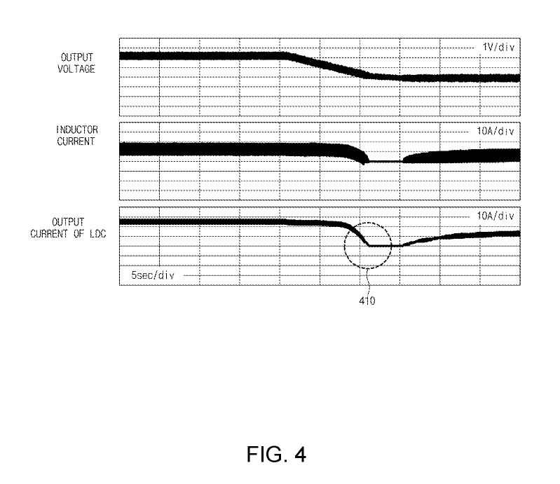

FIG. 4, which is another illustrative view illustrating performance of the apparatus for controlling a synchronizing rectifier of an LDC according to various embodiments of the present invention, illustrates waveforms when an operation of the synchronizing rectifier is controlled on the basis of an output voltage of the LDC when the LDC output command voltage V_{ref} is stepped down from 15.1[V] to 12.8[V] at a load of 300 W.

As illustrated in FIG. 4, it may be appreciated that an operation (on/off) of the synchronizing rectifier 13 is stably performed without a reverse powering phenomenon 410 on a waveform of an output current of the LDC.

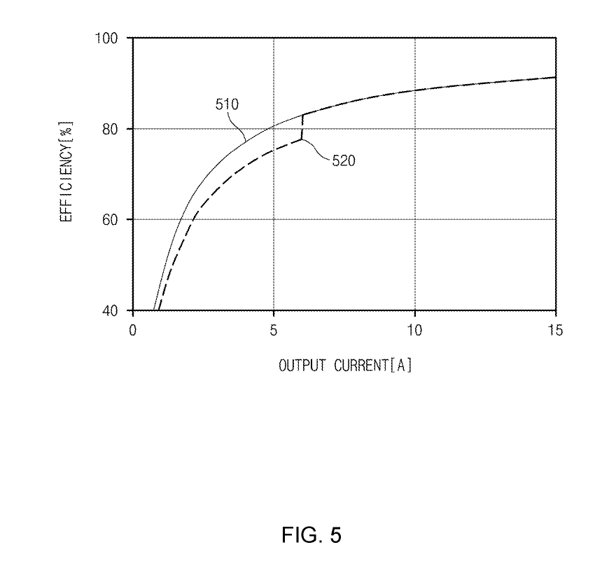

FIG. 5 is still another illustrative view illustrating performance of the apparatus for controlling a synchronizing rectifier of an LDC according to various embodiments of the present invention.

In FIG. 5, ‘510’ indicates efficiency of the LDC in the case in which the operation of the synchronizing rectifier is controlled by a scheme according to various embodiments of the present invention, and ‘520’ indicates efficiency of the LDC in the case in which the operation of the synchronizing rectifier 13 is controlled using an output current of the LDC estimated by the related art. Through FIG. 5, it may be appreciated that the efficiency of the LDC by the scheme according to various embodiments of the present invention is higher than that of the LDC by the related art.

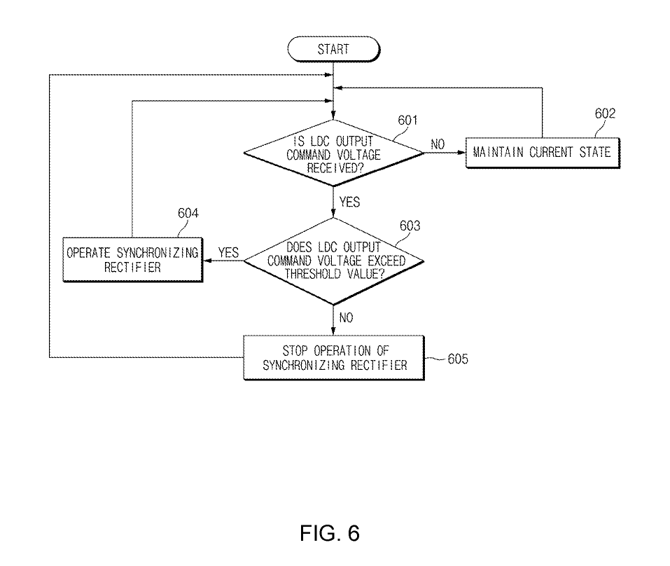

FIG. 6 is a flow chart of a method for controlling a synchronizing rectifier of an LDC according to various embodiments of the present invention, which is performed by the controller 22.

First, the controller 22 confirms whether or not the LDC output command voltage is received (601).

When the LDC output command voltage is not received as a result of the confirmation (601), the controller maintains a current state of the synchronizing rectifier 13 (602). That is, the controller maintains an on-state when the synchronizing rectifier 13 is in the on-state and maintains an off-state when the synchronizing rectifier 13 is in the off-state.

When the LDC output command voltage is received as a result of the confirmation (601), the controller confirms whether or not the LDC output command voltage exceeds a threshold value (603).

When the LDC output command voltage exceeds the threshold value as a result of the confirmation (603), the controller operates (on) the synchronizing rectifier 13 (604).

Then, the method for controlling a synchronizing rectifier of an LDC proceeds to ‘601.’

When the LDC output command voltage does not exceed the threshold value as a result of the confirmation (603), the controller stops (off) an operation of the synchronizing rectifier 13 (605). Here, since current flows through diodes Q5 and Q6 provided in the synchronizing rectifier 13 in a state in which the operation of the synchronizing rectifier is stopped, efficiency of the LDC is decreased, but a rectifying function is normally performed.

Then, the method for controlling a synchronizing rectifier of an LDC proceeds to ‘601.’

Meanwhile, the method for controlling a synchronizing rectifier of an LDC according to various embodiments of the present invention as described above may be created by a computer program. In addition, codes and code segments configuring the computer program may be easily inferred by a computer programmer skilled in the related art. Further, the created computer program is stored in a computer-readable recording medium (information storing medium) and is read and executed by a computer to implement the method for controlling a synchronizing rectifier of an LDC according to various embodiments of the present invention. Further, the computer-readable recording medium includes all types of recording media that are readable by the computer.

As described above, according to various embodiments of the present invention, the operation of the synchronizing rectifier in the LDC provided in the environmentally friendly vehicle is controlled on the basis of the output voltage of the LDC, thereby making it possible to perfectly prevent the reverse powering phenomenon even in an ultra-low load environment without performing a process of estimating the output current of the LDC.

In addition, according to various embodiments of the present invention, the reverse powering phenomenon occurring by the synchronizing rectifier of the LDC provided in the environmentally friendly vehicle may be prevented, and the efficiency of the LDC may be improved.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. An apparatus for controlling a synchronizing rectifier of a voltage direct current (DC)-DC converter, comprising:
a receiver receiving an output command voltage; and
a controller controlling an operation of the synchronizing rectifier based on the received output command voltage
wherein the controller operates the synchronizing rectifier when the controller determines that the output command voltage exceeds a threshold value.

2. The apparatus for controlling the synchronizing rectifier of the converter according to claim 1, wherein the controller stops an operation of the synchronizing rectifier when the output command voltage does not exceed the threshold value.

3. The apparatus for controlling the synchronizing rectifier of the converter according to claim 2, wherein the controller again operates the synchronizing rectifier that is in a stop state when an output command voltage exceeding the threshold value is newly received.

4. A method for controlling a synchronizing rectifier of a voltage direct current (DC)-DC converter, the method comprising:
receiving, by a receiver, an output command voltage; and
controlling, by a controller, an operation of the synchronizing rectifier based on the received output command voltage,
wherein the controlling includes operating, by the controller, the synchronizing rectifier when the controller determines that the output command voltage exceeds a threshold value.

5. The method for controlling the synchronizing rectifier of the converter according to claim 4, wherein the controlling further includes:
stopping, by the controller, an operation of the synchronizing rectifier when the output command voltage does not exceed the threshold value.

6. The method for controlling the synchronizing rectifier of the converter according to claim 5, wherein the controlling includes again operating the synchronizing rectifier that is in a stop state when an output command voltage exceeding the threshold value is newly received.

7. The apparatus for controlling the synchronizing rectifier of the converter according to claim 1, wherein the output command voltage is determined based on a driving condition of a vehicle.

8. The apparatus for controlling the synchronizing rectifier of the converter according to claim 7, wherein the driving condition includes a vehicle stop mode, a deceleration mode, an electrical vehicle mode, a hybrid electrical vehicle mode, a parking mode, and a reverse mode.

9. The apparatus for controlling the synchronizing rectifier of the converter according to claim 7, wherein the output command voltage is determined by a hybrid control unit.

10. The method for controlling the synchronizing rectifier of the converter according to claim 4, wherein the output command voltage is determined based on a driving condition of a vehicle.

11. The method for controlling the synchronizing rectifier of the converter according to claim 10, wherein the driving condition includes a vehicle stop mode, a deceleration mode, an electrical vehicle mode, a hybrid electrical vehicle mode, a parking mode, and a reverse mode.

12. The method for controlling the synchronizing rectifier of the converter according to claim 10, wherein the output command voltage is determined by a hybrid control unit.
